(19) United States
(12) Patent Application Publication
(10) Pub. No.: US 2020/0333072 A1
(43) Pub. Date: Oct. 22, 2020

(54) A DRYING DEVICE FOR PAINTING PRODUCTS

(71) Applicant: Salvatore MORALE, Livorno (IT)

(72) Inventor: Salvatore MORALE, Livorno (IT)

(21) Appl. No.: 16/643,018

(22) PCT Filed: Aug. 1, 2018
(86) PCT No.: PCT/IB2018/055784

§ 371 Date: Feb. 28, 2020

(30) Foreign Application Priority Data
Aug. 31, 2017 (IT) 102017000097871
Aug. 31, 2017 (IT) 102017000097884
Aug. 31, 2017 (IT) 102017000097894

(51) Int. Cl. F26B 3/28; F26B 3/30

(52) U.S. Cl. CPC F26B 3/28; F26B 2210/12; F26B 3/30

(57) ABSTRACT

A drying device for painting products is provided configured to carry out the drying of a vehicle defining a main development axis, a first lateral surface, a second lateral surface, an upper surface and a lower surface; the drying device includes radiant units each defining a radiating surface; and a mobile assembly including a first slider to move a radiant unit along the first lateral surface; a second slider to move a radiant unit along the second lateral surface; a third slider to move a radiant unit along the upper surface; and a fourth slider to move a radiant unit along the lower surface; the sliders may be moved simultaneously along the main development axis maintaining the radiating surfaces overlapping along the main development axis.

The present invention relates to a drying device for painting products of the type specified in the preamble of the first Claim.

In particular, the present device can be used to dry painting products applied to mechanical vehicles, means of transport for transporting people, animals or things. It is ideally suited for drying painting products applied to large mechanical vehicles such as trucks, buses, train/tram coaches, airplanes and preferably rail transport vehicles.

Known drying devices comprise oven chambers for the preparation, painting and drying of painting products, inside which the vehicle with the applied surface coating is placed.

The drying system currently used is hot air drying and the heat necessary for treating surfaces is transmitted by convection.

The hot air is introduced from a plenum located at the top of the oven chamber and extracted through a floor grating of the oven chamber.

The prior art described above has some significant drawbacks.

A significant drawback is the need during the drying step to use a large amount of air, which is introduced from the top of the chamber and extracted by the floor grating.

As a result, the energy consumption of current systems is very high and thus the environmental impact is also very significant.

Another drawback is that known drying devices take a long time to reach the drying temperature due to the need to heat the entire oven chamber.

This is evident when drying trains or other bulky vehicles which require large oven chambers because of their large size.

In addition, these large oven chambers require heating of their entire volume and therefore a high energy consumption in order to be adequately heated.

They are also almost impossible to heat uniformly. This aspect, in conjunction with the specific profile of each vehicle, results in non-homogeneous heating of the vehicle's surfaces and therefore incorrect drying and a poor-quality surface coating.

The slowness and high drying costs of painting products are thus a significant drawback.

Another drawback is that some vehicle surfaces, for example those facing the ground, are poorly heated, making drying problematic.

In these circumstances, the technical task underlying the present invention is to devise a drying device for painting products capable of substantially remedying at least some of said drawbacks.

As part of said technical task, an important object of the invention is to obtain a device which makes possible the rapid, simple and economical drying of painting products applied to large vehicles irrespective of their profiles.

The technical task and the specified objects are achieved by a drying device for painting products as claimed in the appended claim 1. Examples of preferred embodiments are described in the dependent Claims.

Preferred embodiments are highlighted in the dependent Claims.

The characteristics and advantages of the invention will be clarified in the following detailed descriptions of preferred embodiments of the invention, with reference to the accompanying drawings, wherein:

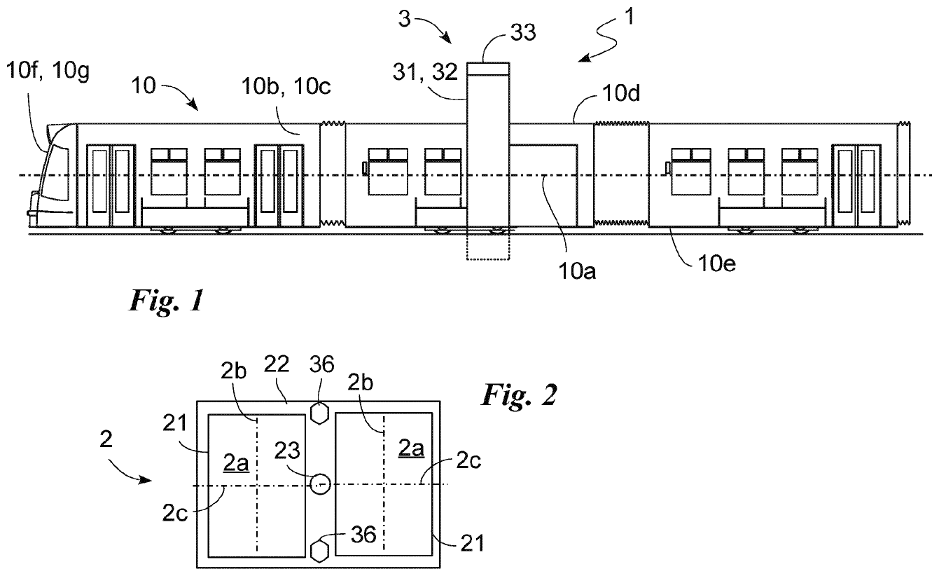

FIG. 1 shows a drying device for painting products according to the invention;

FIG. 2 shows an assembly of the drying device; and

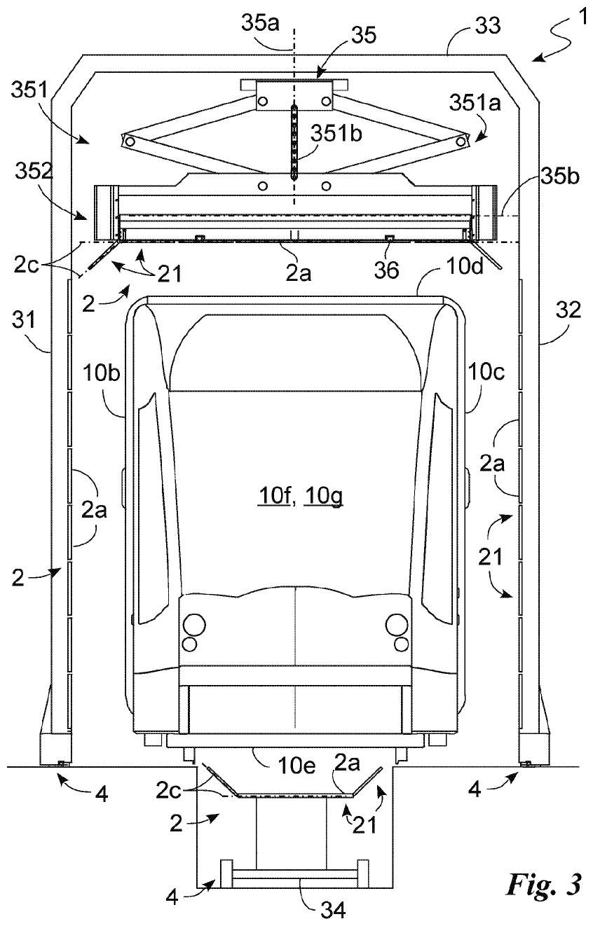

FIG. 3 is another view of the drying device.

In this document, measurements, values, shapes and geometric references (such as perpendicularity and parallelism), when associated with words such as “approximately” or other similar terms such as “almost” or “substantially”, are to be understood as except for measurement errors or inaccuracies due to manufacturing and/or manufacturing errors and, above all, except for a slight deviation from the associated value, measurement, shape or geometric reference. For example, these terms, when associated with a value, preferably indicate a difference not exceeding 10% of the value.

Moreover, when used, terms such as “first”, “second”, “upper”, “lower”, “primary” and “secondary” do not necessarily identify an order, a priority of relation or relative position, but can simply be used to more clearly distinguish between different components.

The measurements and data reported in this text are to be considered, unless otherwise indicated, as having been carried out at ICAO International Standard Atmosphere (ISO 2533).

Unless otherwise stated, as is clear from the following discussions, it is considered that terms such as “processing”, “computer”, “setting”, “calculation”, or the like, refer to the action and/or processes of a computer or similar electronic computing device which manipulates and/or transforms data represented as physical, such as electronic quantities of registers of a computer system and/or its memories, and other data similarly represented as physical quantities within computer systems, registers or other devices for storing, transmitting, or displaying information.

With reference to the Figures, the drying device for painting products according to the invention is indicated in its entirety with the number 1.

The drying device 1 is suitable to dry painting products applied to a vehicle 10. The surface coating may be a paint/colour or other product suitable to perform surface treatments of metallic or polymeric items. Preferably the surface coating is a paint/colourant.

The vehicle 10 defines a main development axis 10a. The main development axis 10a may have an extension of at least 3 m, in detail up to 10 m, and in greater detail up to 30 m.

In use the vehicle 10 defines a plurality of external surfaces including a first lateral surface 10b; a second lateral surface 10c opposite the first lateral surface 10b; an upper surface 10d; a lower surface 10e opposite said upper surface 10d; a front surface 10f; and a rear surface 10g opposite said front surface 10f.

The front surface 10f and rear surface 10 g are inclined and/or perpendicular to the main development axis 10a.

The lateral surfaces 10b and 10c, the upper surface 10d and the lower surface 10e are substantially parallel to the main development axis 10a.

The vehicle 10 is beneficially a train and/or a coach/locomotive of the train.

The drying device 1 comprises at least one radiant unit 2 defining a radiating surface 2a suitable to perform the drying of the surface coating.

The radiating surface 2a defines a longitudinal axis 2b coplanar to said radiating surface 2a and suitably a transverse axis 2c almost perpendicular to the longitudinal axis 2b (FIG. 2).

In use, the longitudinal axis 2b may be almost parallel to the main development axis 10a and preferably the transverse axis 2c is almost perpendicular to the main development axis 10a.

The radiant unit 2 comprises at least one panel 21 defining said radiating surface 2a and suitably the longitudinal axis 2b; and suitably a support frame 22 for said at least one panel 21.

The panel 21 is suitable to heat to a working temperature by bringing up to a drying temperature (the temperature necessary to dry the surface coating) the surface with the surface coating, i.e. one or more of the surfaces 10b, 10c, 10d, 10e, 10f and 10 g of the vehicle 10.

The panel 21 may be a known radiant panel.

The radiant unit 2 preferably comprises several panels 21.

Said panels 21 may define substantially parallel radiating surfaces 2a. Alternatively, one or more of the radiating surfaces 2a of the panels 21 may be transverse to each other with a suitable splay angle of between approximately 30° and 60°.

The radiating surfaces 2a of the panels 21 are parallel to the main development axis 10a at least in use. Suitably, the longitudinal axes 2b are substantially parallel to each other and the transverse axes 2c are substantially parallel to each other.

In detail, the longitudinal axes 2b are substantially coincident i.e. each one defines the extension of the other or preferably the transverse axes 2c are beneficially substantially coincident.

In some cases, the radiant unit 2 may comprise a mover device, for example a linear actuator, suitable to move the two panels reciprocally by changing said splay angle.

The radiant unit 2 comprises a thermal sensor 23 suitable to detect at least one of the drying temperature or the working temperature.

The thermal sensor 23 may beneficially detect the drying temperature.

The thermal sensor 23 may be a pyrometer.

It is arranged along the coincident axes, be they the longitudinal axes 2b or the transverse axes 2c.

The radiant unit 2 preferably comprises at least one pair of panels 21 and the thermal sensor 23 is positioned between the two panels 21 of said pair.

More preferably, the radiant unit 2 comprises more than one pair of panels 21 and a thermal sensor 23 is positioned between the two panels 21 of each pair of panels 21 as shown in FIG. 2.

Even more preferably, the radiant unit 2 comprises three/four pairs of panels 21 and three/four thermal sensors 23 each placed between the two panels 21 of each pair of panels 21.

The radiant unit 2 comprises at least one regulator for said at least one panel 21, depending on what is detected by the thermal sensor 23.

The regulator is suitable to adjust the working temperature of the panel 21 based on the drying temperature detected by the thermal sensor 23. Preferably, the regulator is suitable to adjust/vary the working temperature (of a panel 21 or a pair of panels 21) independently so as to have, for example, panels 21 and/or pairs of panels 21 at different temperatures and/or at the same temperature.

This solution therefore makes it possible to have all the radiating surfaces 2a of a unit 2 at the same temperature and/or to adjust/vary the temperature along the radiating surfaces 2a of a unit 2.

The drying device 1 may comprise a moving member 3 suitable to define a mutual axis of movement between said at least one radiant unit 2 and the vehicle 10.

The mutual axis of movement is almost parallel to the main development axis 10a.

It is also substantially parallel to the non-coincident axes, be they the longitudinal axes 2b or the transverse axes 2c.

A mobile assembly 3 may comprise at least one slider supporting one or more radiant units 2, and, for each slider, a guide defining said mutual axis of movement.

In detail, the mobile assembly 3 may comprise at least one first slider 31 suitable to move at least one radiant unit 2, preferably only one, along at least part of the first lateral surface 10b; at least one second slider 32 suitable to move at least one radiant unit 2, preferably only one, along at least part of the second lateral surface 10c; at least one third slider 33 suitable to move at least one radiant unit 2, preferably one, along at least part of the upper surface 10d; and at least one fourth slider 34 suitable to move at least one radiant unit 2, preferably one, along at least part of the lower surface 10e.

Preferably, the mobile assembly 3 comprises a single group of sliders comprising a first slider 31; a second slider 32; a third slider 33; and a fourth slider 34.

In addition, the mobile assembly 3 may comprise an additional slider assembly comprising a first slider 31; a second slider 32; a third slider 33; and a fourth slider 34. Said additional slider assembly may be moved independently of and preferably in the opposite direction to said slider assembly, so as to halve the drying time for vehicles such as railway carriages which extend a long distance along the axis 10a.

The first slider 31 is suitable to move a radiant unit 2 along the entire first lateral surface 10b, suitably having almost coplanar radiating surfaces 2a. It may have suitably coincident axes (in detail, the transverse axes 2c), substantially perpendicular to the longitudinal axis 10a.

The second slider 32 is suitable to move a radiant unit 2 along the entire second lateral surface 10c, suitably having almost coplanar radiating surfaces 2a. It may have suitably coincident axes (in detail, the transverse axes 2c), substantially perpendicular to the longitudinal axis 10a.

The third slider 33 is suitable to move at least one radiant unit 2 along the entire upper surface 10d and preferably at least part of and in detail the entire front surface 10f and the entire rear surface 10g.

A radiant unit 2 is attached to the third slider 33 and has almost coplanar radiating surfaces 2a and appropriately transverse axes 2c substantially perpendicular to the axis 10a. Alternatively, a radiant unit 2 is associated with the third slider 33 and has substantially coplanar radiating surfaces 2a of the centre panels 21; surfaces 2a of the outer panels 21 inclined with respect to those of the centre panels 21; and transverse axes 2c substantially perpendicular to the axis 10a.

The fourth slider 34 is suitable to move at least one radiant unit 2 along part of, and in detail the whole of, the lower surface 10e.

It is suitable to move a unit 2 with panels 21 having almost coplanar radiating surfaces 2a and appropriately transverse axes 2c substantially perpendicular to the axis 10a. Alternatively, the unit 2 associated with the fourth slider 34 has substantially coplanar radiating surfaces 2a of the centre panels 21; surfaces 2a of the outer panels 21 inclined with respect to those of the centre panels 21; and substantially coplanar longitudinal axes 2b.

The sliders 31, 32, 33 and 34 are moved simultaneously maintaining, during drying, the radiating surfaces overlapping along the main development axis 10a and appropriately the longitudinal axes 2b substantially lying in a single plane perpendicular to the main development axis 10a.

As an alternative or in addition, one or more of the sliders 31, 32, 33 and 34 may be moved independently of the other sliders.

In some cases, the first slider 31, the second slider 32 and the third slider 33 are joined together. In detail, they define a mobile bridge/portal structure (FIG. 3) wherein the first slider 31 and the second slider 32 define the columns of the bridge and the third slider 33 defines the crossbar of said bridge subtended between said columns.

The fourth slider 34 may be structurally separate from the other sliders 31, 32 and 33 and may thus be moved independently.

The mobile assembly 3 may comprise at least one mover device 35 suitable to move a radiant unit 2 and in particular the radiating surface 2a (i.e. the panel 21) with respect to the slider supporting said unit 2, adjusting the distance from the surface with the surface coating to be dried.

The mobile assembly 3 may comprise, for a slider 31, 32, 33 and 34, a mover device 35 suitable to move all the radiating surfaces 2a of the unit 2 attached to it.

Alternatively, for a slider 31, 32, 33 and 34, the mobile assembly 3 may comprise several mover devices 35, each of which is suitable to move one or more surfaces 2a which are thus moveable synchronously together or independently.

Preferably, the mobile assembly 3 comprises a mover device 35 suitable to move the radiant unit 2 supported by a slider, preferably the third slider 33, with respect to it so as to allow it also to dry the front surface 10f and the rear surface 10g.

The mover device 35 may comprise a translator 351 suitable to define a translation axis 35a of said radiant unit 2 with respect to the mobile assembly 3 and thus to the vehicle 10.

The translation axis 35a is substantially perpendicular to the radiating surface 2a.

The translator 351 may comprise at least one pair of articulated arms 351a defining the translation axis 35a and a control body 351b along said translation axis 35a.

In the case of the mover device 35 suitable to move the radiant unit 2 with respect to the third slider 33, the control body 351b may comprise a cable/chain suitable to control the translation and to support the weight of the radiant unit 2. As a result, the function of the articulated arms 351a is purely guidance.

The mover device 35 may comprise a rotation device 352 defining a rotation axis 35b of said radiant unit 2 with respect to the mobile assembly 3 and thus to the vehicle 10.

The rotation axis 35b is substantially parallel to the radiating surface 2a and in particular to the transverse axis 2c.

The rotation device 352 may comprise a hinge defining the rotation axis 35b and a motor to control said rotation.

The mover device 35 may comprise the translator 351 and the rotation device 352, suitably interposed between the translator 351 and the radiant unit 2.

The mobile assembly 3 may comprise at least one distance meter 36 suitable to detect the distance between the radiating surface 2a and the vehicle 10, i.e. between the radiating surface 2a and the surface of the vehicle 10 with the surface coating to be dried.

Preferably, the mover device 35 comprises two distance meters 36 spaced apart in a direction perpendicular to the coincident axes, in particular along the longitudinal axis 2b and more particularly, the main development axis 10a. Preferably, the two distance meters 36 are on opposite sides to the radiating surface 2a and to be precise to the radiant unit 2.

The mobile assembly 3 may comprise a control board for the mover device 35 depending on the distance between the radiating surface 2a and the vehicle 10.

The control board is suitable to substantially maintain the distance between the radiating surface 2a and the vehicle 10 at a fixed value, suitably constant, and in particular to maintain said distance within a working range.

When at least one of the distance meters 36 detects a change in distance and in particular a distance between the radiating surface 2a and the vehicle 10 outside the working range, the control board commands a movement of the radiant unit 2.

To be precise, the control board may command: a rotation around the rotation axis 35b if the distances detected are different from each other; a translation along the translation axis 35a if the distances detected by the distance meters 36 are equal to each other but different from that desired (or outside said working range); and simultaneously both a rotation around the rotation axis 35b and a translation along the translation axis 35a if the distances detected by the distance meters 36 are different from each other and from that desired (or outside said working range).

It should be noted that the latter condition (roto-translation) may occur in the vicinity of a front or rear surface 10f, 10g. These surfaces do not develop substantially along the main development axis 10a, the resulting distances detected by the distance meters 36 along the main development axis 10a are unequal, thus requiring a rotation around the rotation axis 35b, and also different from that desired (or outside said working range), thus requiring a translation.

The drying device 1 may comprise an operations control station for the drying device 1.

The control station may control the operation of one or more radiant units 2 according to the characteristics of the surface coating to be dried.

The control station may control the movement of one or more of the radiant units 2 along the vehicle according to the vehicle's profile.

This profile can be determined by the distance meter 36.

Alternatively, it is preloaded to the control station and the distance meter 36, if any, is suitable to check that the distance is correctly maintained.

The control station may comprise one or more input and/or output devices for information such as the profile of the vehicle 10 and/or the drying temperature.

The control station may control the drying process described below.

The operation of the drying device 1 described above in structural terms defines an innovative new drying process.

The drying process provides that the vehicle 10 remain stationary while the radiant units 2 run along it drying the surface coating.

In detail, the drying process involves a drying step wherein the mobile assembly 3 moves at least one radiant unit 2 along the main development axis 10a allowing the drying of at least part of the vehicle 10.

During the drying step, all the radiant units 2 preferably keep the longitudinal axes 2b substantially lying on a single plane suitably perpendicular to the main axis 10a so as to make it possible to dry the entire vehicle 10.

During the drying step, the control station can determine, for example on the basis of an input received, the drying temperature according to the characteristics of the surface coating and preferably the drying time, as well as the travel velocity of the mobile assembly 3.

At the same time as the drying step, the drying process may comprise a drying temperature thermoregulation step.

During the thermoregulation step, the thermal sensor 23 detects the drying temperature at the panel 21 and/or on the surface to be dried.

If the drying temperature detected is not that desired, the regulator regulates the operation of one or more panels 21 by changing the working temperature and thus allowing the drying temperature values to be brought back to the desired values. It should be noted that the detection of an incorrect drying temperature may also lead to an adjustment of the panels of the radiant units 2 adjacent to the unit 2 with the thermal sensor 23 which has detected the incorrect drying temperature.

At the same time as the drying step, the drying process may comprise a control step for checking the distance between the radiating surface 2a and the vehicle 10 and in particular the surface with the surface coating to be dried.

During the control step, the distance of at least one radiating surface 2a from the vehicle 10, i.e. from the corresponding surface 10d, 10f or 10g of the vehicle 10 and/or suitably from a corresponding surface 10b, 10c, 10d, 10e, 10f or 10g, is maintained within a predefined working range.

If at least one of the distance meters 36 detects that said distance is outside the working range, the control board commands the movement of one or more radiant units 2 in order to bring said distance into said working range. In particular, if the distances measured are different from each other, the control board commands a rotation around the rotation axis 35b. If the distances measured by the distance meters 36 are equal to each other but different from the desired distance, the control board commands a translation along the translation axis 35a.

The drying process may involve simultaneous drying, thermoregulation, and control.

The drying device 1 according to the invention achieves important benefits.

The device 1, by simultaneously moving the four sliders 31, 32, 33 and 34, simultaneously heats and dries portions of the lateral surfaces 10b and 10c, the upper surface 10d and the lower surface 10e, thus creating a ring substantially surrounding an entire section of the vehicle 10 which is uniformly heated and thus such as to guarantee optimal drying of the surface coating.

Another benefit is the presence of the thermal sensor 23 and the regulator which make it possible to have excellent control over the temperature and therefore over the drying of the surface coating.

A significant benefit is achieved thanks to the special mover device 35 and the presence of one or more distance meters 36.

Implementation of these technical solutions makes possible movement of the radiant units 2 while keeping the radiating surfaces 2a always almost parallel to the drying surfaces and at the correct distance from the surface to be dried, irrespective of any irregularities in the profile.

In addition, provision of one or more sliders with the special mover device even makes it possible for the drying device 1 to dry the rear surface 10g and the front surface 10f.

Other key benefits arise from the fact that the drying device 1 is not required to heat an entire oven chamber and thus has consumption and drying times which are much reduced compared to known drying devices.

The invention is subject to variations falling within the scope of the inventive concept as defined by the Claims. In this context all the details are replaceable by equivalent elements and the materials, shapes and dimensions can be any.

1. A drying device for painting products configured to carry out the drying of a vehicle;
said vehicle defining
a main development axis;
a first lateral surface;
a second lateral surface opposite to the first lateral surface;
an upper surface;
a lower surface opposite the upper surface;
said drying device comprising:
a plurality of radiant units defining a radiating surface configured to perform the drying of said surface coating;
a mobile assembly comprising
a first slider configured to move at least one of said radiant units along at least part of said first lateral surface;
a second slider configured to move at least one of said radiant units along at least part of said second lateral surface;
a third slider configured to move at least one of said radiant units along at least part of said upper surface; and
a fourth slider configured to move at least one of said radiant units along at least part of said lower surface; and
wherein said sliders are moveable simultaneously along said main development axis maintaining said radiating surfaces overlapping each other along said main development axis.

2. The drying device according to claim 1, wherein said radiating surface defines a longitudinal axis; and wherein said sliders may be moved simultaneously along said main development axis maintaining said longitudinal axes lying substantially in a single plane perpendicular to said main development axis.

3. The drying device according to claim 1, wherein said first slider, said second slider and said third slider are joined together.

4. The drying device according to claim 3, wherein said first slider, said second slider and said third slider define a mobile bridge structure wherein said first slider and said second slider define the columns of said bridge and said third slider defines the crossbar of said bridge between said columns.

5. The drying device according to claim 1, wherein said mobile assembly comprises a mover device configured to move said at least one radiant unit with respect to said slider supporting said radiating unit.

6. The drying device according to claim 5, wherein said mover device comprises a translator configured to define a translation axis of said radiant unit.

7. The drying device according to claim 5, wherein said mover device comprises a rotation device defining a rotation axis of said radiant unit.

8. The drying device according to claim 5, wherein said mobile assembly comprises at least one distance meter configured to measure the distance between said radiating surface and said vehicle.

9. The drying device according to claim 5, wherein said radiating surface defines said longitudinal axis and a transverse axis substantially perpendicular to said longitudinal axis; wherein said mobile assembly comprises two of said distance meters which are spaced along said transverse axis and a control board for said mover device which is configured to control rotation of said radiant unit around said rotation axis when said distance meters measure different distances and translation of said radiant unit along said translation axis when said distance meters measure equal distances which are different from a desired distance.

10. A drying device for painting products configured to carry out the drying of a vehicle comprising
at least one radiant unit comprising at least one panel defining a radiating surface configured to perform the drying of said surface coating.
said at least one panel, being configured to be heated to a working temperature bringing the surface with said surface coating to be dried to a drying temperature;
wherein said radiant unit comprises
a thermal sensor configured to detect at least one of said drying temperature or said working temperature;
a regulator configured to change said working temperature based on the temperature measured by said thermal sensor.

11. The drying device according to claim 10, wherein said thermal sensor is configured to detect said drying temperature and said regulator is configured to change said working temperature based on said drying temperature.

12. The drying device according to claim 10, wherein said radiant unit comprises at least one pair of said at least one panel; and, for each of said pairs of panels, one of said thermal sensors positioned between said two panels of said pair of panels; and wherein said radiant unit comprises three of said at least one pair of said at least one panel; and three of said at least one thermal sensor each of which is positioned between said panels of said pair of panels.

13. The drying device according to claim 10, wherein said radiating surface defines a longitudinal axis and a transverse axis; and wherein said radiant unit comprises a plurality of said at least one panel having said longitudinal axes lying substantially on a single plane.

14. A drying device for painting products configured to carry out drying of a vehicle and comprising
at least one radiant unit defining a radiating surface configured to dry said surface coating and defining a longitudinal axis and a transverse axis substantially perpendicular to said longitudinal axis;
a mobile assembly which moveable with respect to said vehicle comprising a slider supporting at least one radiant unit; and
wherein said mobile assembly comprises
at least one mover device configured to move said radiant unit with respect to said slider supporting said radiant unit so as to adjust the distance between said radiating surface and the surface with said surface coating of said vehicle to be dried.

15. The drying device according to claim 14, wherein said mobile assembly comprises
two distance meters, spaced apart on said transverse axis, each of which is configured to measure a distance from said surface with said surface coating to be dried; and
a control board configured to control said mover device based on said distances measured by said distance meters by changing the distance between said radiating surface and said surface with said surface coating to be dried.
